(19) United States
(12) Patent Application Publication
(10) Pub. No.: US 2017/0286193 A1
(43) Pub. Date: Oct. 5, 2017

(54) APPLICATION CALLING MANAGEMENT METHOD AND APPARATUS

(71) Applicant: Beijing Xiaomi Mobile Software Co., Ltd., Beijing (CN)

(72) Inventors: Baolin WANG, Beijing (CN); Ming LIU, Beijing (CN); Nan LI, Beijing (CN)

(73) Assignee: Beijing Xiaomi Mobile Software Co., Ltd., Beijing (CN)

(21) Appl. No.: 15/473,068

(22) Filed: Mar. 29, 2017

Related U.S. Application Data
(63) Continuation of application No. PCT/CN2016/087396, filed on Jun. 28, 2016.

(30) Foreign Application Priority Data
Mar. 30, 2016 (CN) 201610191089.3

(51) Int. Cl. G06F 9/54; H04W 52/02

(52) U.S. Cl. CPC G06F 9/546; H04W 52/0264

(57) ABSTRACT

The present disclosure relates to an application calling management method and apparatus, which pertain to the field of computer technology. The method includes: acquiring a background calling message sent by a first application, the background calling message requesting at least one target application to be called; determining a calling rule corresponding to a current calling, according to the background calling message; if a first calling rule matching the calling rule corresponding to the current calling exists in a terminal-disallowing-calling list, determining from the at least one target application at least one application disallowed to be called according to the first calling rule, where the terminal-disallowing-calling list includes at least one calling rule for controlling disallowance of calling, and the at least one application disallowed to be called is all or some of the at least one target application; and disallowing starting in background the application disallowed to be called.

### CROSS-REFERENCE TO RELATED APPLICATIONS

This application is based on and claims the priority of the Chinese patent application No. 201610191089.3, filed on Mar. 30, 2016 to the Chinese Patent Office and entitled “Application Calling Management Method and Apparatus”, and the priority of the PCT patent application No. PCT/CN2016/087396, filed on Jun. 28, 2016, the entire contents of which are incorporated herein by reference in their entirety.

### TECHNICAL FIELD

The present disclosure is related to the field of computer technology, and more particularly to an application calling management method and apparatus.

### BACKGROUND

With development of computer technology, terminals such as handsets become necessities for modern people. Various applications installed in terminals have brought about convenience to people's work and life. For example, online shopping applications can be used for shopping, and office applications can be used for work. When an application is started on a terminal, it may cause other applications to operate at the background. These other applications may push information to the terminal, thereby increasing the power consumption of the terminal.

### SUMMARY

The present disclosure provides an application calling management method and apparatus.

According to a first aspect of embodiments of this disclosure, an application calling management method is provided. The method may include: acquiring a background calling message sent by a first application, the background calling message requesting at least one target application to be called; determining a calling rule corresponding to a current calling according to the background calling message; if a first calling rule matching the calling rule corresponding to the current calling exists in a terminal-disallowing-calling list, determining from the at least one target application at least one application disallowed to be called according to the first calling rule, where the terminal-disallowing-calling list may include at least one calling rule for controlling disallowance of calling, and the at least one application disallowed to be called is at least some of the at least one target application; and disallowing starting in background the application disallowed to be called.

According to a second aspect of the embodiments of this disclosure, an application calling management apparatus is provided. The apparatus may include: a processor; and a memory configured to store instructions executable by the processor. The processor may be configured to: acquire a background calling message sent by a first application, the background calling message requesting at least one target application to be called; determine a calling rule corresponding to a current calling according to the background calling message; if a first calling rule matching the calling rule corresponding to the current calling exists in a terminal-disallowing-calling list, determine from the at least one application at least one application disallowed to be called according to the first calling rule, where the terminal-disallowing-calling list may include at least one calling rule for controlling disallowance of calling, and the at least one application disallowed to be called is at least some of the at least one target application; and disallow starting in background the application disallowed to be called.

According to a third aspect of the embodiments of this disclosure, an application calling management method is provided. The method may include: receiving a background calling message sent by a first application and determining at least one target application corresponding to the background calling message; acquiring a pre-stored terminal-disallowing-calling list corresponding to the first application, the terminal-disallowing-calling list recording at least one application; and starting in background an application among the at least one target application which is not included in the terminal-disallowing-calling list, and disallowing starting in background an application among the at least one target application which is included in the terminal-disallowing-calling list.

It should be understood that both the foregoing general description and the following detailed description are only exemplary and explanatory and are not restrictive of the disclosure.

### BRIEF DESCRIPTION OF THE DRAWINGS

The accompanying drawings herein which are incorporated into and constitute a part of the description, illustrate the embodiments according to the present disclosure, and serve to explain the principles of the present disclosure together with the description.

FIG. 1 is a flow chart showing an application calling management method according to an embodiment.

FIG. 2 is a flow chart showing an application calling management method according to another embodiment.

FIG. 3 is a schematic diagram of a main interface according to an embodiment.

FIG. 4 is a flow chart showing an application calling management method according to yet another embodiment.

FIG. 5 is a block diagram of an application calling management apparatus according to an embodiment.

FIG. 6 is a block diagram of an application calling management apparatus according to another embodiment.

FIG. 7 is a block diagram of an application calling management apparatus according to yet another embodiment.

FIG. 8 is a block diagram of an application calling management apparatus according to a further embodiment.

FIG. 9 is a block diagram of an application calling management apparatus according to yet a further embodiment.

FIG. 10 is a block diagram of an application calling management apparatus according to still a further embodiment.

FIG. 11 is a schematic diagram of a terminal according to an embodiment.

The above drawings illustrate specific embodiments of the disclosure which will be described in detail hereinafter. These drawings and description are not intended to limit the scope of the inventive concept in any way but to explain the concept of the disclosure to those skilled in the art by referring to the specific embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples of the present disclosure. Also, common but well-understood elements that are useful or necessary in a commercially feasible example are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

Reference will now be made in detail to certain embodiments, examples of which are illustrated in the accompanying drawings. The following description refers to the accompanying drawings in which the same numbers in different figures represent the same or similar elements unless otherwise indicated. The implementations set forth in the following description of embodiments do not represent all implementations consistent with the disclosure. Instead, they are merely examples of devices and methods consistent with aspects related to the disclosure as recited in the appended claims.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an example is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Before describing how to implement this disclosure, a process for an application to call another application and start it in background is explained. The system program of a terminal provides an application in the terminal with a function of calling another application to start it in background. An application may send a background calling message to the system program. After receiving the background calling message, the system program may start an application corresponding to the background calling message in background, namely, start the application and run the same in background.

Each step of the methods of the embodiments of this disclosure may be executed by a terminal. The system program of the terminal may be an Android system program. The terminal may be any terminal supporting installation of applications, such as a smart phone, a tablet computer or any other mobile terminal. The terminal may be provided with a processor, a memory, a transceiver and the like. The processor may be configured to manage callings of applications. The memory may store instructions, data required and generated in the following processes. The transceiver may receive and send messages. The terminal may also be provided with input/output devices, such as a screen. The screen may display interfaces (such as a setting interface) and may be a touch screen. In the embodiments of this disclosure, solutions are described in detail by taking a case where the terminal is a handset and the system program is an Android system program as an example. The implementation in other cases is similar to the implementation in the exemplary case and is not described herein redundantly.

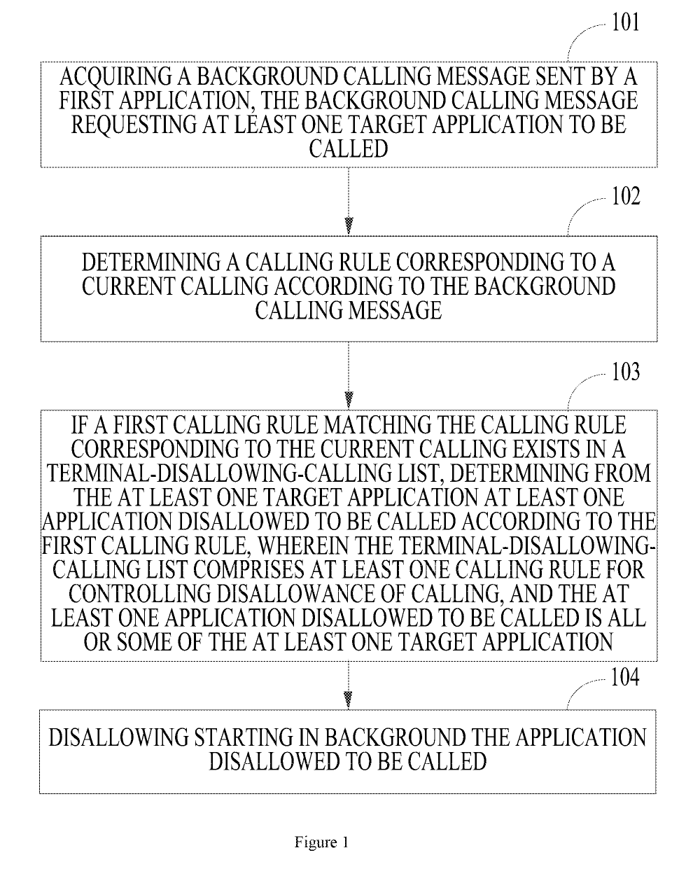

FIG. 1 is a flow chart showing an application calling management method according to an embodiment. The process of this method may include the following steps.

In step 101, a background calling message sent by a first application is acquired. The background calling message requests at least one target application to be called.

In step 102, a calling rule corresponding to the current calling is determined according to the background calling message.

In step 103, if a first calling rule matching the calling rule corresponding to the current calling exists in a terminal-disallowing-calling list, at least one application disallowed to be called is determined from the at least one target application according to the first calling rule. The terminal-disallowing-calling list comprises at least one calling rule for controlling disallowance of calling, and the at least one application disallowed to be called is all or some of the at least one target application.

In step 104, it is disallowed to start in background the application disallowed to be called.

To sum up, with the method provided by this embodiment, a calling rule corresponding to a current calling is determined according to a background calling message; if a first calling rule matching the calling rule corresponding to the current calling exists in a terminal-disallowing-calling list, at least one application disallowed to be called is determined from the at least one target program according to the first calling rule; and it is disallowed to start in background the application disallowed to be called. In this way, when the first application calls and starts in background other applications, the system program can disallow starting in background some application(s) based on the terminal-disallowing-calling list. Thus, the power consumption of the terminal can be reduced.

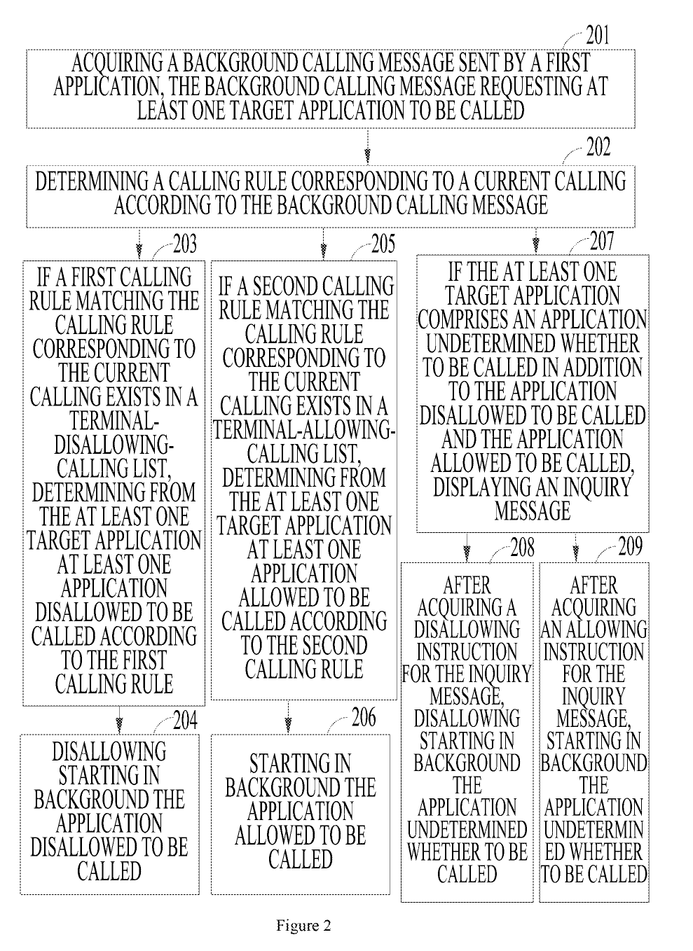

FIG. 2 is a flow chart showing an application calling management method according to another embodiment. The process of this method may include the following steps.

In step 201, a background calling message sent by a first application is acquired. The background calling message requests at least one target application to be called.

The first application is installed in a terminal. After being started (in background or foreground) and run, the first application may send the background calling message to a system program which may be an application on a Framework layer of the terminal. The first application may be started in foreground when being opened by a user or in background when being called by another application. The background calling message may be sent in any of four calling types including Start activity, Send broadcast, Start service (bind service) and Get content provider, and is configured to request the target application to be called.

In a possible implementation, the background calling message carries an application identification for indicating a target application requested by the first application to be called. Optionally, the background calling message further carries a target class name, which indicates a class of the target application requested by the first application to be called. For example, if the application identification carried by the background calling message is a package name “Com.test.b” of the application and the target class name carried by the background calling message is “Com.test.push.sdk.PUshService”, it means that the first application requests a target application whose package name is “Com.test.b” and whose class name is “Com.test.push.sdk.PUshService” to be called.

In a possible implementation, the background calling message carries target operation information (namely, action) which indicates a called operation. Among applications installed in the terminal, an application, supporting an operation corresponding to the target operation information, is the target application requested by the first application to be called. In an example, if the target operation information carried by the background calling message is “Com.text.SEND_MESSAGE” which indicates that the called operation is message sending, it means that the first application requests all applications capable of performing message sending to be called among the applications installed in the terminal. Among the applications installed in the terminal, there may be one or more applications capable of performing message sending.

In step 202, a calling rule corresponding to a current calling is determined according to the background calling message.

The calling rule corresponding to the current calling may include at least one of a caller, a callee, a called operation (namely, an action), a called class name and a calling type.

1) If the calling rule corresponding to the current calling includes a caller for the current calling, the terminal may determine the caller for the current calling by determining the first application sending the background calling message as the caller for the current calling. For example, if a package name of the first application is “Com.test.a,” the caller for the current calling is the application whose package name is “Com.test.a.”

2) If the calling rule corresponding to the current calling includes a callee for the current calling, the terminal may determine the callee for the current calling according to the following implementations.

In a possible implementation, the terminal acquires an application identification carried by the background calling message, and determines a target application indicated by the application identification as the callee for the current calling. For example, if package names of applications carried by the background calling message are “Com.test.b” and “Com.test.c”, callees for the current calling are two applications whose package names are “Com.test.b” and “Com.test.c” respectively.

In another possible embodiment, the terminal acquires target operation information carried by the background calling message, and determines among locally installed applications a target application supporting an operation corresponding to the target operation information as the callee for the current calling. For example, if the target operation information carried by the background calling message is “Com.text.SEND_MESSAGE” and, among the applications locally installed in the terminal, applications capable of performing message sending include applications A and B, then callees for the current calling are applications A and B.

3) If the calling rule corresponding to the current calling includes a called operation for the current calling, the terminal may determine the called operation for the current calling by acquiring target operation information carried by the background calling message and determining an operation corresponding to the target operation information as the called operation for the current calling. For example, if the target operation information carried by the background calling message is “Com.text.SEND_MESSAGE,” the called operation for the current calling is message sending.

4) If the calling rule corresponding to the current calling includes a called class name for the current calling, the terminal may determine the called class name for the current calling by acquiring a target class name carried by the background calling message and determining the target class name as the called class name for the current calling. For example, if the target class name carried by the background calling message is “Com.test.push.sdk.PUshService,” the called class name for the current calling is “Com.test.push.sdk.PUshService.”

5) If the calling rule corresponding to the current calling includes a current calling type, the terminal may determine the calling type for the current calling by determining a target calling type adopted by the first application for sending the background calling message as the calling type for the current calling. As described above, a caller may adopt any of four calling types including Start activity, Send broadcast, Start service (bind service) and Get content provider to send the background calling message. If the target calling type adopted by the first application for sending the background calling message is Start activity, the calling type for the current calling is Start activity.

The terminal may extract one or more of a caller, a callee, a called operation, a called class name and a calling type according to information carried by the background calling message, to determine a calling rule corresponding to the current calling. In an example, if the calling rule corresponding to the current calling includes the caller “Com.test.a”, the callee “Com.test.b”, the called class name “Com.test.push.sdk.PUshService” and the calling type “Start service”. In another example, the calling rule corresponding to the current calling includes the called operation “Com.text.SEND_MESSAGE” and the calling type “Send broadcast”.

In the present embodiment, the terminal stores a terminal-disallowing-calling list including at least one calling rule for controlling disallowance of calling. The terminal disallows performing a calling process which conforms to a calling rule included in the terminal-disallowing-calling list. Optionally, the terminal also stores a terminal-allowing-calling list including at least one calling rule for controlling allowance of calling. The terminal allows performing a calling process which conforms to a calling rule included in the terminal-allowing-calling list.

Taking a terminal-disallowing-calling list as an example, calling rules included in the terminal-disallowing-calling list may be as shown in Table 1.

TABLE 1

| Caller Package Name | Callee Package Name | Called class name | Called operation (action) | Calling type |
|---|---|---|---|---|
| Com.test.a | Com.test.b | Com.test.push.sdk. | * | Start service |
| | | PUshService | | |
| * | Com.test.a | Com.test.push.sdk. | * | Start service |
| | | PUshService | | |
| * | * | * | Com.text.SEND_MESSAGE | Start service |
| * | * | * | android.net.conn. | * |
| | | | CONNECTIVITY_CHANGE | |
| Com.text.a | Com.test.b | Com.test.push.sdk | * | * |

In Table 1, “*” represents a wildcard to enable a calling rule to cover as many calling relations as possible, so that the number of calling rules required to be included in a terminal-disallowing-calling list is reduced, thereby facilitating saving storage resources of the terminal. Taking the third calling rule shown in Table 1 as an example, as long as the called operation is “Com.text.SEND_MESSAGE” and the adopted calling type is “Send broadcast”, any calling process will conform to the calling rule, regardless of its caller, callee and called class name.

The calling rules included in a terminal-allowing-calling list may be used in the same or similar way as the calling rules from terminal-disallowing-calling list. The calling rules included in the terminal-allowing-calling list may also have the same or similar format as the calling rules shown in Table 1 for the terminal-disallowing-calling list. However, sometimes, the calling rules included in the terminal-allowing-calling list may have different formats from the calling rules shown in Table 1 for the terminal-disallowing-calling list. Any formats that store a list that may be used for determining the permission for a calling process to be called should be in the scope of this disclosure.

Sometimes, a partial wildcard may be introduced for both terminal-disallowing-calling list and the terminal-allowing-calling list. For example, in the above example, for the third calling rule shown in Table 1, Rather than “*” in the caller package name, “Com.text.*” may be provided, in this case, all caller package name starting with “Com.text.” may conform to this calling rule.

After the calling rule corresponding to the current calling is determined, it is detected whether a first calling rule matching the calling rule corresponding to the current calling exists in the terminal-disallowing-calling list, and it is detected whether a second calling rule matching the calling rule corresponding to the current calling exists in the terminal-allowing-calling list. In the present embodiment, the order for performing the two detection steps may vary. Optionally, the terminal may first detect whether a second calling rule matching the calling rule corresponding to the current calling exists in the terminal-allowing-calling list to ensure that a calling process allowed to be performed is performed first.

In step 203, if a first calling rule matching the calling rule corresponding to the current calling exists in a terminal-disallowing-calling list, at least one application disallowed to be called is determined from the at least one target application according to the first calling rule.

For example, the calling rule corresponding to the current calling may include a caller “Com.test.a”, a callee “Com.test.b”, a called class name “Com.test.push.sdk.PUshService” and the calling type “Start service”. If calling rules included in the terminal-disallowing-calling list are as shown in Table 1, then the first calling rule in the terminal-disallowing-calling list matches the calling rule for the current calling, and the terminal determines the application whose package name is “Com.test.b” as an application disallowed to be called.

In addition, the at least one application disallowed to be called is all or some of the at least one target application. For example, the calling rule corresponding to the current calling may include the caller “Com.test.a”, the callees “Com.test.b” and “Com.test.c”, the called class name “Com.test.push.sdk.PUshService” and the calling type “Start service”. The at least one target application requested by the first application to be called may include two applications whose package names are “Com.test.b” and “Com.test.c”. The application whose package name is “Com.test.b” is an application disallowed to be called, and the application whose package name is “Com.test.c” is not an application disallowed to be called.

In step 204, it is disallowed to start in background the application disallowed to be called.

In one possible implementation, an alert may be generated and may be displayed to the user in the terminal to list the application disallowed to be called. Sometimes, the application disallowed to be called may be overwritten by the user. For example, when the user is altered through a terminal that an application is disallowed to be called, the terminal may provide an option to the user to overwrite such disallowance and enable the disallowed application to be called. Further, such overwriting may be good only for one time or the disallowance may be overwritten permanently. When the disallowance is overwritten permanently, the application may be removed from the terminal-disallowing-calling list and may be added to the terminal-allowing-calling list.

In step 205, if a second calling rule matching the calling rule corresponding to the current calling exists in a terminal-allowing-calling list, at least one application allowed to be called is determined from at least one target application according to the second calling rule.

For example, the calling rule corresponding to the current calling may include a called operation “Com.text.SEND_MESSAGE” and a calling type “Send broadcast”. If the terminal-allowing-calling list includes the third calling rule as shown in Table 1 and, among the applications locally installed in the terminal, the application capable of performing message sending include applications A and B, then the terminal may determine that the applications A and B are applications allowed to be called.

In addition, the at least one application allowed to be called is all or some of the at least one target application. For example, the calling rule corresponding to the current calling may include a called operation “Com.text.SEND_MESSAGE” and a calling type “Send broadcast”. In the terminal-allowing-calling list, the second calling rule matching the calling rule corresponding to the current calling includes a callee “application A”, a callee operation “Com.text.SEND_MESSAGE” and a calling type “Send broadcast”. Still assuming that, among the applications locally installed in the terminal, applications capable of performing message sending include applications A and B, then the terminal may determine that the application A is an application allowed to be called, and the application B is not an application allowed to be called.

In step 206, the application allowed to be called is started in background.

In one possible implementation, an alert may be generated by the terminal to display to the user the application allowed to be called in the background. Sometimes, the terminal may provide the user an option to change or overwrite the status for the application allowed to be called to disallow the application allowed to be called. When an application is changed from an allowed process to a disallowed process, the change or the overwriting may be good for one time or may be permanent. When the status for an application is changed or overwritten permanently, the application may be removed from the terminal-allowing-calling list and may be added to the terminal-disallowing-calling list.

Optionally, the method provided by the present embodiment may further include steps 207-209.

In step 207, if the at least one target application further includes an application undetermined whether to be called in addition to the application disallowed to be called and the application allowed to be called, an inquiry message is displayed.

The inquiry message may be used for inquiring a user whether the application undetermined whether to be called is allowed to be called. For example, the at least one target application may include applications A, B and C. The applications A and B are applications disallowed to be called, while the application C is neither an application disallowed to be called nor an application allowed to be called. Then, the terminal determines that the application C is an application undetermined whether to be called and displays the inquiry message used for inquiring the user whether the application C is allowed to be called. For instance, the inquiry message may be “The first application attempts to start the application C. Allow or not allow?”

The user may trigger a disallowing instruction or an allowing instruction according to the inquiry message displayed by the terminal.

In step 208, after a disallowing instruction for the inquiry message is acquired, it is disallowed to start in background the application undetermined whether to be called.

In step 209, after an allowing instruction for the inquiry message is acquired, the application undetermined as to whether to be called is started in background.

When the allowing or disallowing instruction for the inquiry message is acquired, the terminal may update the terminal-allowing-calling list or the terminal-disallowing-calling list to add the undetermined application to the relevant list.

In conclusion, according to the method provided by the present embodiment, a calling rule corresponding to a current calling is determined according to the background calling message; if a first calling rule matching the calling rule corresponding to the current calling exists in a terminal-disallowing-calling list, at least one application disallowed to be called is determined from at least one target application according to the first calling rule; and it is disallowed to start in background the application disallowed to be called. In this way, when the first application calls and starts other applications in background, the system program can disallow starting some application(s) in background based on the terminal-disallowing-calling list. Thus, the power consumption of the terminal can be reduced.

In addition, by setting a terminal-allowing-calling list, if a second calling rule matching the calling rule corresponding to the current calling exists in the terminal-allowing-calling list, an application allowed to be called is determined from the at least one target application according to the second calling rule, and is started in background. As such, it is ensured that some applications allowed to be called can be called normally.

Furthermore, if the at least one target application further includes an application undetermined whether to be called in addition to the application disallowed to be called and the application allowed to be called, an inquiry message is displayed for inquiring a user whether the application undetermined whether to be called is allowed to be called, so that the user may autonomously determine whether to allow the application undetermined whether to be called to be called. Thus, calling between applications may not be performed without permission by the system or user, thereby the system security is improved.

There may be the following problems if an application is called in background without control: 1) security risks, caused by that, after being called and started in background, the application may perform a series of operations which affect the security, such as reading the user's privacy, positioning, acquiring a payment password or screen recording; 2) power consumption, caused by that, after being started and run in background, the application consumes power (which may be in large amount, especially when functions of positioning, screen recording, sound recording and the like are enabled) resulting in shorter standby time of the terminal and discharge of heat from the device; 3) memory space occupation, caused by that, after being started and run in background, the application occupies the memory space, resulting in such problems for the terminal as insufficient memory and standstill; and 4) too much pushed messages, caused by that pushed messages may be sent after the application is started and run in background. With the technical solutions provided in the present disclosure, all applications cannot be called without permission by the system or user, so that the above problems may be effectively solved. That is, the terminal's power consumption and memory space occupation can be reduced, the terminal's standby time is prolonged, heat discharged from the device is reduced, the number of pushed messages is reduced, and the security is improved.

Embodiments of the present disclosure also provide a method for a terminal to acquire a terminal-disallowing-calling list and a terminal-allowing-calling list. The method may include processes 1 and 2.

In process 1, a list acquiring request is sent to a server.

The list acquiring request may include identifications of applications locally installed in the terminal. The server is configured to acquire calling rules related to the applications locally installed in the terminal from a general calling disallowance list to obtain the terminal-disallowing-calling list, and to acquire calling rules related to the applications locally installed in the terminal from a general calling allowance list to obtain the terminal-allowing-calling list.

In one possible implementation, a technician can collect all applications supported by the Android system. Each terminal enabling a synchronization function may send calling relationships among installed applications to a network server (which is set by the technician to store general calling disallowance lists and general calling allowance lists for applications, and may be shortly referred to as a server).

The technician may sort out and analyze the calling relationships sent by all the terminals to obtain the general calling disallowance lists and the general calling allowance lists and may store them in the server. For example, for callings that may have potential security risks and callings that only serve to push messages to improve the survival rate of some applications, the technician can extract calling rules from such calling relationships and add these calling rules to the general calling disallowance list. As another example, for normal mutual callings among some applications, such as calling relationships of payment, sharing and authorized login, the technician can extract calling rules from such calling relationships and add these calling rules to the general calling allowance list.

The terminal may send identifications of all applications installed therein to the server. After receiving the application identifications, the server may acquire calling rules related to the applications locally installed in the terminal from the general calling disallowance list to obtain the terminal-disallowing-calling list, or may acquire calling rules related to the applications locally installed in the terminal from a general calling allowance list to obtain the terminal-allowing-calling list. The server may send the terminal-disallowing-list and the terminal-allowing-calling list to the terminal.

In process 2, the terminal-disallowing-calling list and the terminal-allowing-calling list sent by the server are received.

After receiving the terminal-disallowing-calling list and the terminal-allowing-calling list sent by the server, the terminal may store the list.

Considering that there may be abundant applications on the Android platform and there may be millions of calling relationships among the applications, sending calling rules related to the applications locally installed in the terminal to the terminal instead of directly sending the general calling disallowance list and the general calling allowance list to the terminal may be conducive for saving the storage resource of the terminal and improving the matching efficiency of the calling rules.

In addition, embodiments of the present disclosure also provide a method for a terminal to update a terminal-disallowing-calling list and a terminal-allowing-calling list. The method may include other processes 1 and 2.

In other process 1, when a preset list updating condition is met, a list updating request is sent to a server.

The list updating request may carry identifications of all applications currently installed in the terminal. The server may be configured to acquire calling rules related to the applications locally installed in the terminal from a general calling disallowance list to obtain the terminal-disallowing-calling list, and to acquire calling rules related to the applications locally installed in the terminal from a general calling allowance list to obtain the terminal-allowing-calling list.

In other process 2, the terminal-disallowing-calling list and the terminal-allowing-calling list sent by the server are received to replace original stored ones.

There may be two preset list updating conditions: when a new application is installed in the terminal and whenever a predetermined time period elapses. In the following, these conditions are described in detail.

In one possible implementation, when a user installs a new third application in the terminal, the terminal may send a list updating request to the server after detecting the locally installed third application. The list updating request may carry identifications of all applications currently installed in the terminal. After receiving the list updating request sent from the terminal, the server may derive the identifications of all the applications currently installed in the terminal from the list updating request, acquire calling rules related to the applications locally installed in the terminal from a pre-stored general calling disallowance list to obtain a terminal-disallowing-calling list and calling rules related to the applications locally installed in the terminal from a pre-stored general calling allowance list to obtain a terminal-allowing-calling list, and may send the terminal-disallowing-list and the terminal-allowing-calling list to the terminal. After receiving the terminal-disallowing-calling list and the terminal-allowing-calling list sent by the server, the terminal may store the new received lists to replace originals ones.

Alternatively, the technician can set a certain time period (a predetermined periodicity), and store it in the terminal. The terminal may send a list updating request to the server at the predetermined periodicity (e.g., every one week, two weeks, etc.). The list updating request may carry identifications of all applications currently installed in the terminal. After receiving the list updating request sent by the terminal, the server may perform the above-described operations.

The terminal regularly updating the terminal-disallowing-calling list and the terminal-allowing-calling list from the server may be conducive for reducing the number of times for a user to choose whether to allow calling, thereby simplifying the user's operations and improving the user experience.

Embodiments of the present disclosure also provide a method for a user to modify authorization of the first application to call another application. The method may include additional processes 1 and 2.

In additional process 1, at least one calling disallowance rule related to the first application is displayed.

In an example, each calling disallowance rule related to the first application may include an application disallowed to be called by the first application.

In additional process 2, when a calling authorization instruction corresponding to a target calling disallowance rule is acquired, the target calling disallowance rule is deleted from the terminal-disallowing-calling list, and is added into the terminal-allowing-calling list as a calling allowance rule.

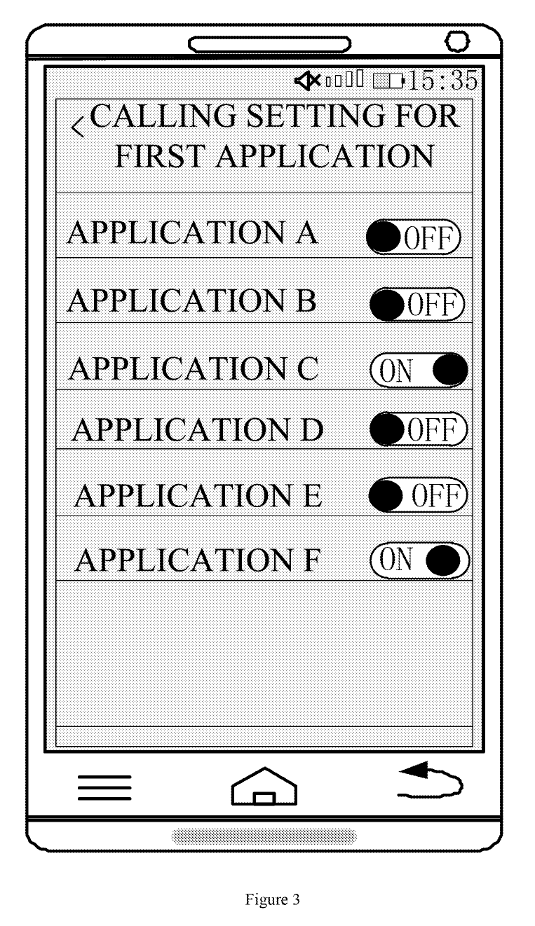

The target calling disallowance rule may be one of at least one calling disallowance rule related to the first application. In one possible implementation, the technician may enable application calling settings for all applications installed in the terminal to be displayed in settings of the terminal. For example, FIG. 3 illustrates application calling settings for the first application. If a user wants to modify the authorization of the first application to call other applications, he/she may click the on/off option. The on option is used for triggering authorization of the first application to call another application, and the off option is used for disabling authorization of the first application to call another application.

If the user wants to enable the first application to call a second application and start it in background, he/she may switch the on/off option for the second application in the application calling setting for the first application from the off option to the on option. Thus, when detecting a calling authorization instruction input by the user for authorizing the first application to call the second application, the terminal can modify the terminal-disallowing-calling list and the terminal-allowing-calling list, so that the first application may call the second application and may start it in background.

Similarly, embodiments of the present disclosure also provide a method for a user to modify prohibition of the first application from calling another application. The method may include further processes 1 and 2.

In further process 1, at least one calling allowance rule related to the first application is displayed.

In an example, each calling allowance rule related to the first application may include an application allowed to be called by the first application.

In further process 2, when a calling prohibition instruction corresponding to a target calling allowance rule is acquired, the target calling allowance rule is deleted from the terminal-allowing-calling list, and is added into the terminal-disallowing-calling list as a calling disallowance rule.

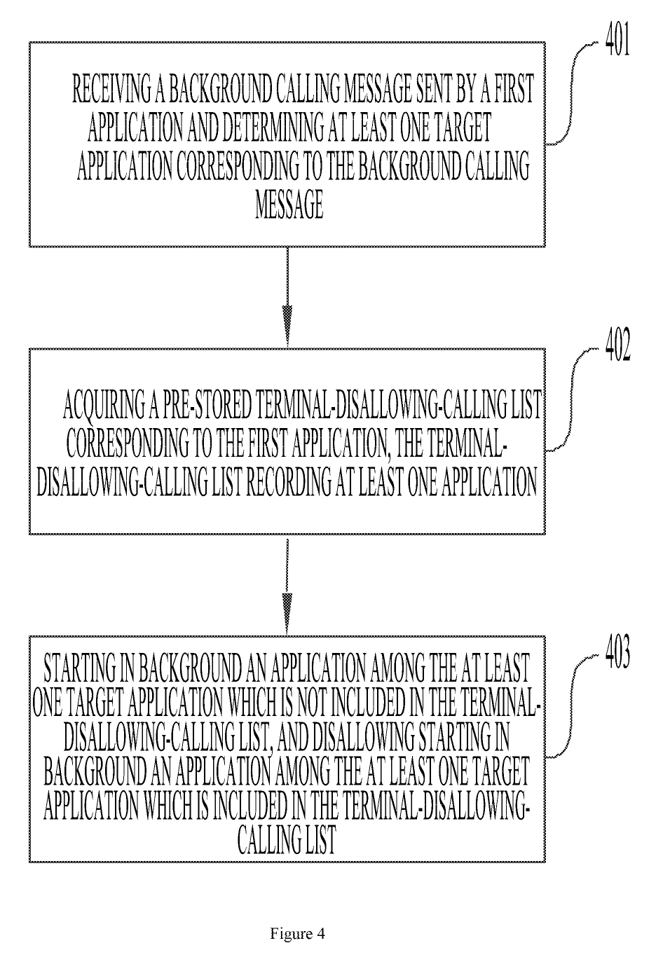

FIG. 4 is a flow chart showing an application calling management method according to another exemplary embodiment. The processing flow of the method may include the following steps.

In step 401, a background calling message sent by a first application is received, and at least one target application corresponding to the background calling message is determined.

In one possible implementation, the first application is installed in a terminal. After being started (in background or in foreground), the first application may send a background calling message to a system program. The first application may be started in foreground when being opened by a user or in background when being called by another application. The background calling message may be sent in any of four calling types including Start activity, Send broadcast, Start service (bind service) and Get content provider. After receiving the background calling message sent by the first application, the system program can determine the target application corresponding to the background calling message based on an application identification or operation information carried by the background calling message, and determine all applications to be called by the first application that may require.

Optionally, if the background calling message carries the application identification, the step of determining the at least one target application may include: determining the target application corresponding to the application identification carried by the background calling message.

In one possible implementation, when the first application sends the background calling message to the system program, an identification of an application to be called may be carried by the background calling message. After receiving the background calling message sent by the first application, the system program can derive from the background calling message that may carry application identification. The target application may be an application corresponding to the carried application identification.

Optionally, if the background calling message carries target operation information, the step of determining the target application may include: determining among locally installed applications an application supporting an operation corresponding to the target operation information as the target application.

The target operation information (namely, action) may be information specifying the target application that may performs certain processing, or may be any string preset between a calling application and a called application.

In one possible implementation, when the first application sends the background calling message to the system program, the target operation information may be carried by the background calling message. After receiving the background calling message, the system program can determine among locally installed applications a target application supporting an operation corresponding to the target operation information. A target application may be capable of receiving the target operation information.

In step 402, a pre-stored terminal-disallowing-calling list corresponding to the first application is acquired. The terminal-disallowing-calling list records at least one application.

In one possible implementation, a technician can collect all applications supported by the Android system. Each terminal enabling a synchronization function may send calling relationships among installed applications to a network server (which is set by the technician to store general calling disallowance lists for applications, and may be shortly referred to as a server). Then the technician may determine the general calling disallowance list corresponding to each application according to calling relationships sent by all terminals, and may store the general calling disallowance lists in the server.

The general calling disallowance list corresponding to each application may include calling applications and called applications. Each terminal may send identifications of all applications installed therein to the server. After receiving the application identifications sent by the terminal, the server may determine, from the general calling disallowance lists, matched terminal-disallowing-calling lists for all applications installed in the terminal, and send the matched terminal-disallowing-calling list to the terminal. After receiving the terminal-disallowing-calling lists for all installed applications, the terminal may store the lists.

As shown in Table 2, a terminal-disallowing-calling list corresponding to the first application includes all applications that cannot be called by the first application to be started in background. For example, if the first application is the Xiaomi store application, the terminal-disallowing-calling list corresponding to the Xiaomi store application may include applications A, B, C and the like.

After determining a target application corresponding to the background calling message, the system program can acquire from the terminal a pre-stored terminal-disallowing-calling list corresponding to the first application according to an identification of the first application.

TABLE 2
Terminal-disallowing-calling list for First Application

| Application | Applications disallowed to be called |
|---|---|
| Xiaomi shore | Application A |
| | Application B |
| | Application C |
| | . . . |

Optionally, the terminal-disallowing-calling list may further include a calling type, and a corresponding process may be as follows.

A target calling type corresponding to the background calling message may be determined; and the pre-stored terminal-disallowing-calling list corresponding to both the first application and the target calling type may be acquired, and the terminal-disallowing-calling list may record at least one application.

The calling type may be Start activity, Send broadcast, Start service (bind Service) or Get content provider.

In one possible implementation, since different calling types may adopt different operation information, a technician can set a terminal-disallowing-calling list corresponding to each calling type when setting operation information corresponding to called applications in a general calling disallowance list in the server, and store the terminal-disallowing-calling list in the server. Each terminal may acquire from the server terminal-disallowing-calling lists corresponding to calling types for each application installed therein, and store the terminal-disallowing-calling lists. As such, a terminal-disallowing-calling list corresponding to a calling type can be found if there are various calling types, and then applications disallowed to be called in background can be determined, without having to find them from a mixed terminal-disallowing-calling list for four calling types, thus the efficiency may be improved for determining the applications disallowed to be started in background.

After receiving the background calling message, the system program of the terminal may determine a target calling type corresponding to the background calling message, and then acquire a pre-stored terminal-disallowing-calling list corresponding to both the first application and the target calling type.

In step 403, an application among the at least one target application which is not included in the terminal-disallowing-calling list is started in background, and it is disallowed to start in background an application among the at least one target application which is included in the terminal-disallowing-calling list.

In one possible implementation, the system program of the terminal may determine an application included in the terminal-disallowing-calling list and an application not included in the terminal-disallowing-calling list among target applications corresponding to the background calling message according to the terminal-disallowing-calling list corresponding to the first application, and then start in background the application not included in the terminal-disallowing-calling list and disallow starting in background the application included in the terminal-disallowing-calling list. For example, among the target applications, if the system program determines that the application A is included in the terminal-disallowing-calling list and the applications B and C are not included in the terminal-disallowing-calling list, the system program controls the applications B and C to be started in background and disallows starting in background the application A.

Optionally, if the background calling message carries operation information (action) which may be referred to as target operation information, the terminal-disallowing-calling list may record operation information corresponding to each of the at least one application. The step 403 may be implemented as: disallowing starting in background an application among the at least one target application which is included in the terminal-disallowing-calling list and whose corresponding operation information is the same as the target operation information.

For an application among the at least one target application which is included in the terminal-disallowing-calling list and whose corresponding operation information is different from the target operation information, it may be started in background.

The target operation information may be information specifying that the target application may perform a certain processing, or may be any string preset between a calling application and a called application.

In one possible implementation, a technician may add operation information corresponding to a called application in the general calling disallowance list corresponding to each application. Accordingly, the terminal-disallowing-calling lists for all installed applications, acquired by each terminal, may also include operation information. The process of acquiring the terminal-disallowing-calling lists for all the installed applications by each terminal is the same as that of step 402, and is described in detail herein.

After receiving the background calling message sent by the first application, the system program of the terminal may acquire target operation information carried by the message, and determine among the at least one target application applications which are included in the terminal-disallowing-calling list. Then, the system program may compare the determined applications with the terminal-disallowing-calling list to check whether the operation information is the same as the target operation information. If no, an application whose operation information is different from the target application information is started in background; and if yes, it is disallowed to start in background an application whose operation information is the same as the target application information.

Optionally, if the terminal-disallowing-calling list includes a called class name, step 403 may be implemented as: determining a target called class name corresponding to the background calling message; disallowing starting in background an application which is included in the terminal-disallowing-calling list and whose corresponding called class name is the same as the target called class name; and starting in background an application which is included in the terminal-disallowing-calling list and whose corresponding called class name is different from the target called class name.

The target called class name may be a name of a function code in an application for performing an operation corresponding to the target operation information; and one called class name may correspond to several pieces of operation information. The technician may set one or more function codes for each application, and correspondingly may define the name (the called class name) of each function code.

In one possible implementation, a technician may add a called class name corresponding to a called application in the general calling disallowance list corresponding to each application. Accordingly, the terminal-disallowing-calling may list for all installed applications, acquired by each terminal, may also include called class names. The process of acquiring the terminal-disallowing-calling lists for all the installed applications by each terminal may be the same as that of step 402, and is described in detail herein. The technician may preset corresponding relations between called class names and operation information, and may store the relations in the terminal.

After receiving the background calling message sent by the first application, if the background calling message carries operation information, the system program of the terminal can determine a called class name corresponding to the background calling message according to the pre-stored corresponding relations between called class names and operation information, and determine among the at least one target application applications which are included in the terminal-disallowing-calling list. The system program may compare the determined applications with the terminal-disallowing-calling list to check whether the called class name is the same as the target called class name. If not, an application whose called class name is different from the target called class name may be started in background; and if yes, it is disallowed to start in background an application whose called class name is the same as the target called class name.

If the background calling message does not carry operation information, default operation information may be acquired. Then, a called class name corresponding to the background calling message may be determined according to the pre-stored corresponding relations between called class names and operation information, and applications which are included in the terminal-disallowing-calling list may be determined from the at least one target application. The determined applications may be compared with the terminal-disallowing-calling list to check whether the called class name is the same as the target called class name. If not, an application whose called class name is different from the target called class name is started in background; if yes, it is disallowed to start in background an application whose called class name is the same as the target called class name.

In addition, for a case where the terminal-disallowing-calling list includes both operation information and a called class name, if a plurality of applications simultaneously send background calling messages to the system program of the terminal, the system program may receive large amount of operation information. Because the terminal-disallowing-calling list includes the called class name, the system program can check whether a terminal called class name is the same as the target called class name. If not, an application whose called class name is different from the target called class name is started in background; if yes, it is disallowed to start in background an application whose called class name is the same as the target called class name. As such, there may be no need to compare each operation information with the terminal-disallowing-calling list, thereby improving the efficiency for the system program to determine applications to be started in background and applications disallowed to be started in background.

Optionally, according to a target calling type corresponding to the background calling message, an application among the at least one target application which is not included in the terminal-disallowing-calling list may be started in background, and it is disallowed to start an application among the at least one target application which is included in the terminal-disallowing-calling list. The target calling type may be any one of Start activity, Send broadcast, Start service (bind service) and Get Content Provider.

In one possible implementation, the target calling type may include one of: Start activity, Send broadcast, Start service (bind service) and Get Content Provider. After receiving a background calling message sent by the first application, the system program may determine a calling type, determine a target application (according to a process similar to that of step 401), and then may find a terminal-disallowing-calling list corresponding to the first application. For different calling types, the system program may start in background an application among the at least one target application which is not included in the terminal-disallowing-calling list and then may send the target calling type to the application which is not included in the terminal-disallowing-calling list, and may disallow starting in background an application among the at least one target application which is included in the terminal-disallowing-calling list.

In conclusion, according to the method provided by the present embodiment, at least one target application corresponding to a background calling message may be determined by receiving the background calling message sent by the first application; a pre-stored terminal-disallowing-calling list corresponding to the first application may be acquired, and the terminal-disallowing-calling list may record at least one application; an application among the at least one target application which is not included in the terminal-disallowing-calling list may be started in background, and it is disallowed to start in background an application among the at least one target application which is included in the terminal-disallowing-calling list. In this way, when the first application calls and starts other applications in background, the system program can disallow starting some application(s) in background based on the terminal-disallowing-calling list. Thus, the power consumption of the terminal can be reduced.

It should be noted that, in the above-described embodiments shown in FIG. 4, description may be just given as an example, in which calling rules in the general terminal-disallowing-calling list and the general terminal-allowing-calling list include callers and callees and in which respective terminal-disallowing-calling lists and respective terminal-allowing-calling lists may be established for different callers. In this case, after determining a caller and a callee for the current calling according to the background calling message, the terminal can quickly determine a matched terminal-disallowing-calling list corresponding to the caller for the current calling, so as to determine an application disallowed to be called.

The following are apparatus embodiments of the present disclosure, which may be configured to perform the method embodiments of the present disclosure. For details that are not disclosed in the apparatus embodiments of the present disclosure, reference can be made to the method embodiments of the present disclosure.

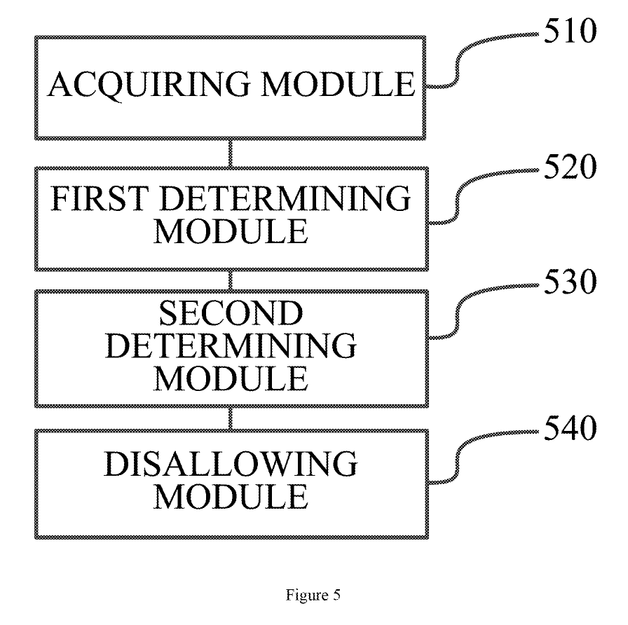

FIG. 5 is a block diagram of an application calling management apparatus according to an embodiment. The apparatus is able to implement the above methods, and may be implemented by hardware or by hardware running corresponding software. The apparatus may include: an acquiring module 510, a first determining module 520, a second determining module 530 and a disallowing module 540.

The acquiring module 510 may be configured to acquire a background calling message sent by a first application, the background calling message requesting at least one target application to be called.

The first determining module 520 may be configured to determine a calling rule corresponding to a current calling according to the background calling message.

The second determining module 530 may be configured to, if a first calling rule matching the calling rule corresponding to the current calling exists in a terminal-disallowing-calling list, determine from the at least one target application at least one application disallowed to be called according to the first calling rule, where the terminal-disallowing-calling list may include at least one calling rule for controlling disallowance of calling, and the at least one application disallowed to be called may be all or some of the at least one target application.

The disallowing module 540 may be configured to disallow starting in background the application disallowed to be called.

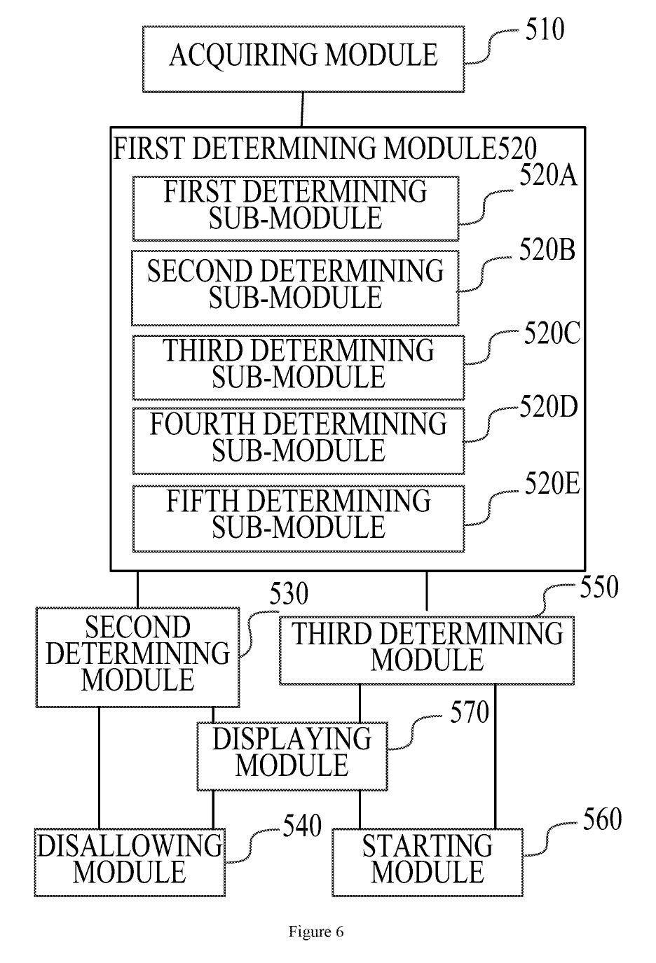

Optionally, as shown in FIG. 6, the apparatus may further include a third determining module 550 and a starting module 560.

The third determining module 550 may be configured to, if a second calling rule matching the calling rule corresponding to the current calling exists in a terminal-allowing-calling list, determine from the at least one target application at least one application allowed to be called according to the second calling rule, where the terminal-allowing-calling list may include at least one calling rule for controlling allowance of calling, and the at least one application allowed to be called may be all or some of the at least one target application.

The starting module 560 may be configured to start in background the application allowed to be called.

Optionally, as shown in FIG. 6, the apparatus may further include a displaying module 570.

The displaying module 570 may be configured to, if the at least one target application comprises an application undetermined whether to be called in addition to the application disallowed to be called and the application allowed to be called, display an inquiry message for inquiring a user whether the application undetermined whether to be called is allowed to be called.

The disallowing module 540 may be further configured to, after a disallowing instruction for the inquiry message is acquired, disallow starting in background the application undetermined whether to be called.

The disallowing module 540 may be further configured to, after an allowing instruction for the inquiry message is acquired, start in background the application undetermined whether to be called.

Optionally, the calling rule may include at least one of a caller, a callee, a calling operation, a calling class name and a calling type.

Optionally, the calling rule corresponding to the current calling may include a caller for the current calling.

As shown in FIG. 6, the first determining module 520 may include a first determining sub-module 520a.

The first determining sub-module 520a may be configured to determine the first application which sends the background calling message as the caller for the current calling.

Optionally, the calling rule corresponding to the current calling may include a callee for the current calling.

As shown in FIG. 6, the first determining module 520 may include a second determining sub-module 520b.

The second determining sub-module 520b may be configured to acquire an application identification carried by the background calling message, and determine a target application indicated by the application identification as the callee for the current calling.

Or the second determining sub-module 520b may be configured to acquire target operation information carried by the background calling message, and determine among locally installed applications a target application, which supports an operation corresponding to the target operation information, as the callee for the current calling.

Optionally, the calling rule corresponding to the current calling may include a called operation for the current calling.

As shown in FIG. 6, the first determining module 520 may include a third determining sub-module 530c.

The third determining sub-module 530c may be configured to acquire target operation information carried by the background calling message, and to determine an operation corresponding to the target operation information as the called operation for the current calling.

Optionally, the calling rule corresponding to the current calling may include a called class name for the current calling.

As shown in FIG. 6, the first determining module 520 may include a fourth determining sub-module 520d.

The fourth determining sub-module 520d may be configured to acquire a target class name carried by the background calling message, and to determine the target class name as the called class name for the current calling.

Optionally, the calling rule corresponding to the current calling may include a calling type for the current calling.

As shown in FIG. 6, the first determining module 520 may include a fifth determining sub-module 520e.

The fifth determining sub-module 520e may be configured to determine a target calling type adopted by the first application for sending the background calling message as the calling type for the current calling.

Optionally, the apparatus may further include a sending module and a receiving module.

The sending module may be configured to send a list acquiring request to a server, wherein the list acquiring request includes identifications of locally installed applications, and the server may be configured to acquire calling rules related to the locally installed applications from a general calling disallowance list to obtain the terminal-disallowing-calling list, and to acquire calling rules related to the locally installed applications from a general calling allowance list to obtain the terminal-allowing-calling list.

The receiving module may be configured to receive the terminal-disallowing-calling list and the terminal-allowing-calling list sent by the server.

Optionally, the apparatus may further include an authorizing module and/or a prohibiting module.

The authorizing module may be configured to display at least one calling disallowance rule related to the first application, to delete a target calling disallowance rule from the terminal-disallowing-calling list when a calling authorization instruction corresponding to the target calling disallowance rule is acquired, and to add the target calling disallowance rule into the terminal-allowing-calling list as a calling allowance rule.

The prohibiting module may be configured to display at least one calling allowance rule related to the first application, to delete a target calling allowance rule from the terminal-allowing-calling list when a calling prohibition instruction corresponding to the target calling allowance rule is acquired, and to add the target calling allowance rule into the terminal-disallowing-calling list as a calling disallowance rule.

To sum up, with the apparatus provided by this embodiment, a calling rule corresponding to the current calling according to a background calling message may be determined; if a first calling rule matching the calling rule corresponding to the current calling exists in a terminal-disallowing-calling list, an application disallowed to be called may be determined from at least one target application according to the first calling rule; and it is disallowed to start in background the application disallowed to be called. In this way, when the first application calls and starts in background other applications, the system program can disallow starting in background some application(s) based on the terminal-disallowing-calling list. Thus, the power consumption of the terminal can be reduced.

In addition, by setting a terminal-allowing-calling list, if a second calling rule matching the calling rule corresponding to the current calling exists in the terminal-allowing-calling list, an application allowed to be called may be determined from the at least one target application according to the second calling rule, and is started in background. As such, normal calling of some applications allowed to be called may be ensured.

Furthermore, if the at least one target application may further include an application undetermined whether to be called in addition to the application disallowed to be called and the application allowed to be called, an inquiry message may be displayed for inquiring a user whether the application undetermined whether to be called is allowed to be called, so that the user can autonomously determine whether to allow the application undetermined whether to be called to be called. Thus, calling between applications cannot be performed without permission by the system or user, thereby improving the security.

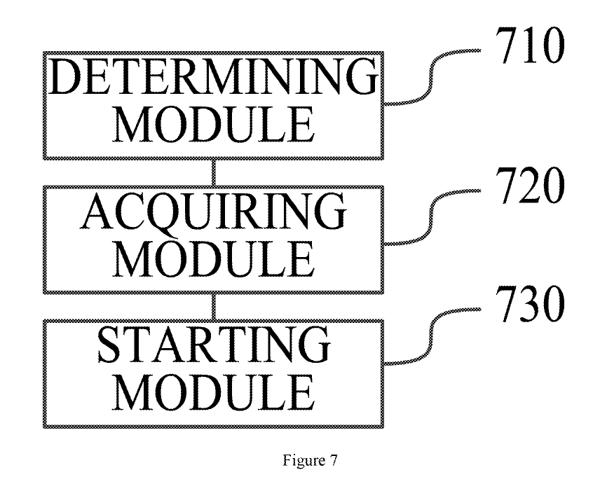

FIG. 7 is a block diagram of an application calling management apparatus according to yet another embodiment. The apparatus is able to implement the above methods, and may be implemented by hardware or by hardware running corresponding software. The apparatus may include: a determining module 710, an acquiring module 720 and a starting module 730.

The determining module 710 may be configured to receive a background calling message sent by a first application and determine at last one target application corresponding to the background calling message.

The acquiring module 720 may be configured to acquire a pre-stored terminal-disallowing-calling list corresponding to the first application, the terminal-disallowing-calling list recording at least one application.

The starting module 730 may be configured to start in background an application among the at least one target application which is not included in the terminal-disallowing-calling list, and to disallow starting in background an application among the at least one target application which is included in the terminal-disallowing-calling list.

Optionally, the background calling message may carry an application identification; and the determining module 710 may be configured to determine a target application corresponding to the application identification carried by the background calling message.

Optionally, the background calling message may carry target operation information; and the determining module 710 may be configured to determine among locally installed applications a target application supporting an operation corresponding to the target operation information.

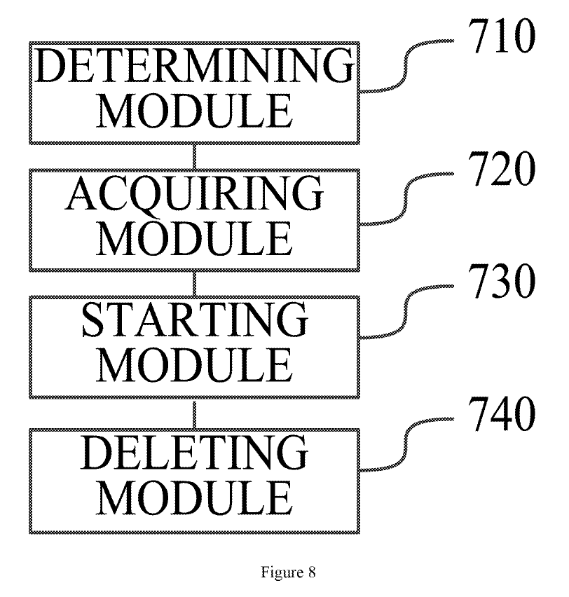

Optionally, as shown in FIG. 8, the apparatus may further include a deleting module 740 configured to, when a calling authorization instruction input by a user for authorizing the first application to call a second application is received, delete the second application from the terminal-disallowing-calling list.

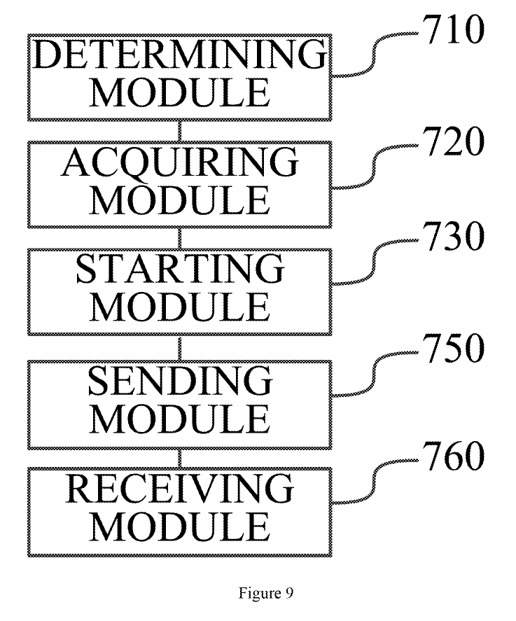

Optionally, as shown in FIG. 9, the apparatus may further include a sending module 750 configured to, when a preset list updating condition is met, send a list updating request to a server, where the list updating request may carry identifications of all applications currently installed in a terminal, so that the server may acquire a stored general calling disallowance list corresponding to each of all installed applications, and may create a terminal-disallowing-calling list corresponding to each application based on applications installed in the terminal and included in the general calling disallowance list; and a receiving module 760 configured to receive from the server the terminal-disallowing-calling list corresponding to each application, and store the same.

Optionally, the background calling message may carry target operation information, and the terminal-disallowing-calling list records operation information corresponding to each of the at least one application. The starting module 730 may be configured to disallow starting in background an application among the at least one target application which is included in the terminal-disallowing-calling list and whose corresponding operation information is the same as the target operation information. The starting module 730 may be further configured to start in background an application among the at least one target application which is included in the terminal-disallowing-calling list and whose corresponding operation information is different from the target operation information.

Optionally, the determining module 710 may be further configured to determine a target calling class name corresponding to the background calling message. The starting module 730 may be configured to disallow starting in background the application among the at least one target application which is included in the terminal-disallowing-calling list and whose corresponding calling class name may be the same as the target calling class name. The starting module 730 may be further configured to start in background an application among the at least one target application which is included in the terminal-disallowing-calling list and whose corresponding calling class name may be different from the target calling class name.

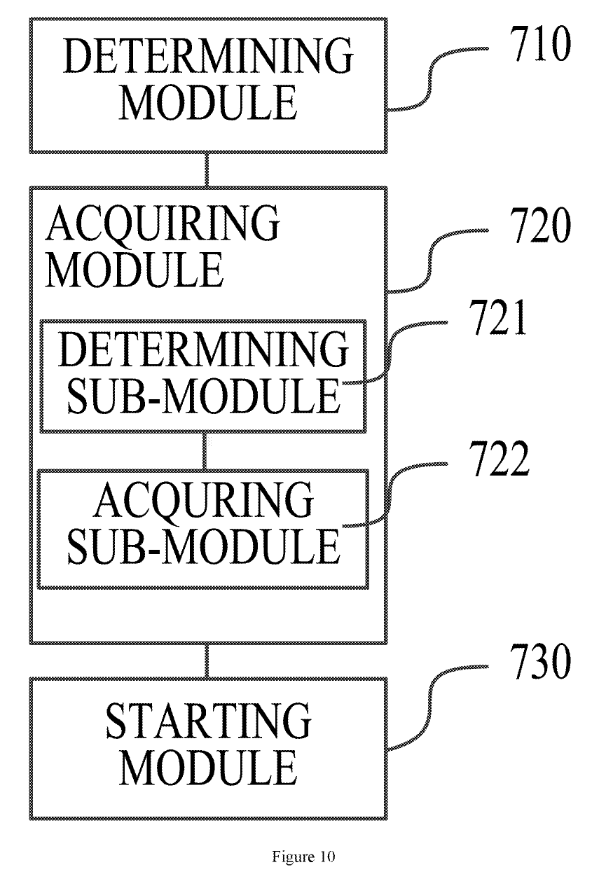

Optionally, as shown in FIG. 10, the acquiring module 720 may include a determining sub-module 721 and an acquiring sub-module 722.

The determining sub-module 721 may be configured to determine a target calling type corresponding to the background calling message.

The acquiring sub-module 722 may be configured to acquire a pre-stored terminal-disallowing-calling list corresponding to both the first application and the target calling type, the terminal-disallowing-calling list recording at least one application.

Optionally, the background calling message may carry calling type information, which may include any one of: Start Activity, Send Broadcast, Start Service (bind Service) and Get Content Provider.

Optionally, the starting module 730 may be configured to, according to the target calling type, start in background the application among the at least one target application which is not included in the terminal-disallowing-calling list, and disallow starting in background the application among the at least one target application which is included in the terminal-disallowing-calling list, the target calling type including any one of: Start Activity, Send Broadcast, Start Service (bind Service) and Get Content Provider.

To sum up, with the apparatus provided by this embodiment, a background calling message sent by a first application may be received, and a target application corresponding to the background calling message may be determined; a pre-stored terminal-disallowing-calling list corresponding to the first application may be acquired, the terminal-disallowing-calling list may record at least one application; and an application among the at least one target application which is not included in the terminal-disallowing-calling list may be started in background, and it is disallowed to start in background an application among the at least one target application which is included in the terminal-disallowing-calling list. As such, when the first application calls and starts in background other applications, the system program can disallow starting some application(s) in background based on the terminal-disallowing-calling list. Thus, the power consumption of the terminal can be reduced.

It should be noted that: when application calling management is performed by using the application calling management apparatus provided by the above embodiments, the above division into respective functional modules is only given by way of example. In practical application, the above functions may be implemented by different functional modules as required; that is, the internal structure of the apparatus may be divided into different functional modules to realize all or part of the above functions. In addition, since the application calling management apparatus and the application calling management method provided by the above embodiments belong to the same concept, reference can be made to the method embodiments for the implementation of the apparatus, and the description thereof is omitted here for simplicity.

An embodiment of this disclosure provides an application calling management apparatus, which can implement the above application calling management methods provided by this disclosure. The apparatus may include: a processor; and a memory configured to store instructions executable by the processor.

The processor may be configured to: acquire a background calling message sent by a first application, the background call message requesting at least one target application to be called; determine a calling rule corresponding to a current calling according to the background calling message; if a first calling rule matching the calling rule corresponding to the current calling exists in a terminal-disallowing-calling list, determine from the at least one target application at least one application disallowed to be called according to the first calling rule, where the terminal-disallowing-calling list may include at least one calling rule for controlling disallowance of calling, and the at least one application disallowed to be called is all or some of the at least one target application; and disallow starting in background the application disallowed to be called.

Optionally, the processor may be further configured to: if a second calling rule matching the calling rule corresponding to the current calling exists in a terminal-allowing-calling list, determine from the at least one target application at least one application allowed to be called according to the second calling rule, where the terminal-allowing-calling list may include at least one calling rule for controlling allowance of calling, and the at least one application allowed to be called may be all or some of the at least one target application; and allow starting in background the application allowed to be called.

Optionally, the processor may be further configured to: if the at least one target application may include an application undetermined whether to be called in addition to the application disallowed to be called and the application allowed to be called, display an inquiry message for inquiring a user whether the application undetermined whether to be called is allowed to be called; after acquiring a disallowing instruction for the inquiry message, disallow starting in background the application undetermined whether to be called; after acquiring an allowing instruction for the inquiry message, start in background the application undetermined whether to be called.

Optionally, the calling rule may include at least one of a caller, a callee, a calling operation, a calling class name and a calling type.

In one example, the calling rule corresponding to the current calling may include a caller for the current calling. The processor may be configured to: determine the first application which sends the background calling message as the caller for the current calling.

In yet another example, the calling rule corresponding to the current calling may include a callee for the current calling. The processor may be configured to: acquire an application identification carried by the background calling message, and determine a target application indicated by the application identification as the callee for the current calling; or acquire target operation information carried by the background calling message, and determine among locally installed applications a target application, which supports an operation corresponding to the target operation information, as the callee for the current calling.

In still another example, the calling rule corresponding to the current calling may include a called operation for the current calling. The processor may be configured to: acquire target operation information carried by the background calling message, and determine an operation corresponding to the target operation information as the called operation for the current calling.

In a further example, the calling rule corresponding to the current calling may include a called class name for the current calling. The processor may be configured to: acquire a target class name carried by the background calling message, and determine the target class name as the called class name for the current calling.

In yet a further example, the calling rule corresponding to the current calling may include a calling type for the current calling. The processor may be configured to: determine a target calling type adopted by the first application for sending the background calling message as the calling type for the current calling.

Optionally, the processor may be further configured to: send a list acquiring request to a server, wherein the list acquiring request includes identifications of locally installed applications, and the server is configured to acquire calling rules related to the locally installed applications from a general calling disallowance list to obtain the terminal-disallowing-calling list, and to acquire calling rules related to the locally installed applications from a general calling allowance list to obtain the terminal-allowing-calling list; and receive the terminal-disallowing-calling list and the terminal-allowing-calling list sent by the server.

Optionally, the processor may be further configured to: display at least one calling disallowance rule related to the first application; when acquiring a calling authorization instruction corresponding to a target calling disallowance rule, delete the target calling disallowance rule from the terminal-disallowing-calling list, and add the target calling disallowance rule into the terminal-allowing-calling list as a calling allowance rule; and/or display at least one calling allowance rule related to the first application; when acquiring a calling prohibition instruction corresponding to a target calling allowance rule, delete the target calling allowance rule from the terminal-allowing-calling list, and add the target calling allowance rule into the terminal-disallowing-calling list as a calling disallowance rule.

Another embodiment of this disclosure provides an application calling management apparatus, which can implement the above application calling management methods provided by this disclosure. The apparatus may include: a processor; and a memory configured to store instructions executable by the processor.

The processor may be configured to: receive a background calling message sent by a first application and determine at least one target application corresponding to the background calling message; acquire a pre-stored terminal-disallowing-calling list corresponding to the first application, the terminal-disallowing-calling list recording at least one application; and start in background an application among the at least one target application which is not included in the terminal-disallowing-calling list, and disallow starting in background an application among the at least one target application which is included in the terminal-disallowing-calling list.

Optionally, the background calling message may carry an application identification. The processor may be configured to: determine a target application corresponding to the application identification carried by the background calling message.

Optionally, the background calling message may carry target operation information. The processor may be configured to: determine, among locally installed applications, a target application supporting an operation corresponding to the target operation information.

Optionally, the processor may be further configured to: when receiving a calling authorization instruction input by a user for authorizing the first application to call a second application, delete the second application from the terminal-disallowing-calling list.

Optionally, the processor may be further configured to: when a preset list updating condition is met, send a list updating request to a server, wherein the list updating request carries identifications of all applications currently installed in a terminal, so that the server may acquire a stored general calling disallowance list corresponding to each of all installed applications, and may create a terminal-disallowing-calling list corresponding to each application based on the applications installed in the terminal and included in the respective general calling disallowance list; and may receive from the server the terminal-disallowing-calling list corresponding to each application and store the same.

Optionally, the background calling message may carry target operation information, and the terminal-disallowing-calling list may record operation information corresponding to each of the at least one application. The processor may be configured to: disallow starting in background an application among the at least one target application which is included in the terminal-disallowing-calling list and whose corresponding operation information may be the same as the target operation information, and start in background the application among the at least one target application which is included in the terminal-disallowing-calling list and whose corresponding operation information may be different from the target operation information.

Optionally, the processor may be further configured to determine a target calling class name corresponding to the background calling message. The processor may be configured to: disallow starting in background an application among the at least one target application which is included in the terminal-disallowing-calling list and whose corresponding calling class name may be the same as the target calling class name; and start in background an application among the at least one target application which is included in the terminal-disallowing-calling list and whose corresponding calling class name may be different from the target calling class name.

Optionally, the processor may be further configured to: determine a target calling type corresponding to the background calling message; and acquire a pre-stored terminal-disallowing-calling list corresponding to both the first application and the target calling type, the terminal-disallowing-calling list recording at least one application.

Optionally, the processor may be configured to: determine a target calling type corresponding to the background calling message; and according to the target calling type, start in background the application among the at least one target application which is not included in the terminal-disallowing-calling list, and disallow starting in background the application among the at least one target application which is included in the terminal-disallowing-calling list, the target calling type including any one of: Start Activity, Send Broadcast, Start Service (bind Service) and Get Content Provider.

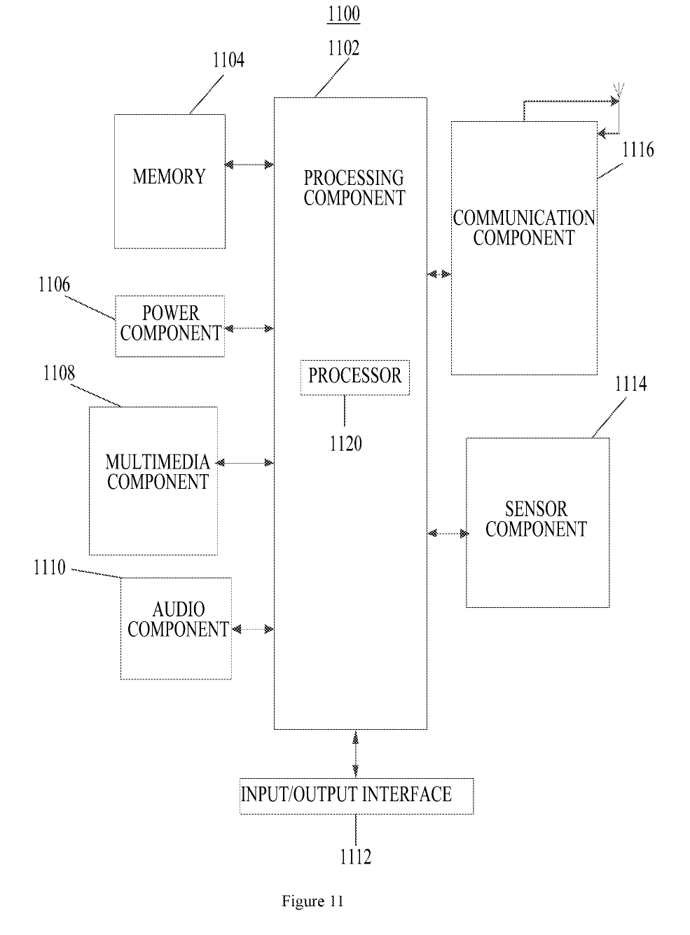

FIG. 11 illustrates a schematic diagram of a terminal according to an embodiment of this disclosure. The terminal may be a handset or the like.

Referring to FIG. 11, the terminal 1100 may include one or more of the following components: a processing component 1102, a memory 1104, a power component 1106, a multimedia component 1108, an audio component 1110, an input/output (I/O) interface 1112, a sensor component 1114 and a communication component 1116.

The processing component 1102 typically controls overall operations of the terminal 1100, such as the operations associated with display, telephone calls, data communications, camera operations and recording operations. The processing component 1102 may include one or more processors 1120 to execute instructions to perform all or some of the steps in the above described methods. Moreover, the processing component 1102 may include one or more modules which facilitate the interaction between the processing component 1102 and other components. For example, the processing component 1102 may include a multimedia module to facilitate the interaction between the multimedia component 1108 and the processing component 1102.

The memory 1104 may be configured to store various types of data to support the operation of the terminal 1100. Examples of such data comprise instructions for any applications or methods operated on the terminal 1100, various kinds of data, messages, pictures, video, etc. The memory 1104 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 may provide power to various components of the terminal 1100. The power component 1106 may include a power management system, one or more power sources, and any other components associated with the generation, management, and distribution of power in the terminal 1100.

The multimedia component 1108 may include a screen providing an output interface between the terminal 1100 and the user. In some embodiments, the screen may include a liquid crystal display (LCD) and a touch panel (TP). If the screen includes the touch panel, the screen may be implemented as a touch screen to receive input signals from the user. The touch panel may include one or more touch sensors to sense touches, swipes and gestures on the touch panel. The touch sensors may not only sense a boundary of a touch or swipe action, but also sense a period of time and a pressure associated with the touch or swipe action. In some embodiments, the multimedia component 1108 includes a front camera and/or a rear camera. The front camera and the rear camera may receive an external multimedia datum while the terminal 1100 is in an operation mode, such as a photographing mode or a video mode. Each of the front camera and the rear camera may be a fixed optical lens system or have focus and optical zoom capability.

The audio component 1110 may be configured to output and/or input audio signals. For example, the audio component 1110 includes a microphone (MIC) configured to receive an external audio signal when the terminal 1100 is in an operation mode, such as a call mode, a recording mode, and a voice recognition mode. The received audio signal may be further stored in the memory 1104 or transmitted via the communication component 1116.

The I/O interface 1112 may provide an interface between the processing component 1102 and peripheral interface modules, such as a keyboard, a click wheel, buttons, and the like. The buttons may include, but are not limited to, a home button, a volume button, a starting button, and a locking button.

The sensor component 1114 may include one or more sensors to provide status assessments of various aspects of the terminal 1100. For instance, the sensor component 1114 may detect an open/closed status of the terminal 1100, relative positioning of components, e.g., the display and the keypad, of the terminal 1100, a change in position of the terminal 1100 or a component of the terminal 1100, presence or absence of user's contact with the terminal 1100, an orientation or an acceleration/deceleration of the terminal 1100, and a change in temperature of the terminal 1100. The sensor component 1114 may include a proximity sensor configured to detect the presence of nearby objects without any physical contact. The sensor component 1114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor or a temperature sensor.

The communication component 1116 may be configured to facilitate communication, wired or wirelessly, between the terminal 1100 and other devices. The terminal 1100 can access a wireless network based on a communication standard, such as WiFi, 2G, or 3G, or a combination thereof. In one embodiment, the communication component 1116 receives a broadcast signal or broadcast associated information from an external broadcast management system via a broadcast channel. In one embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment, the terminal 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above methods.

In an embodiment, there is also provided a non-transitory computer-readable storage medium comprising instructions, such as comprised in the memory 1104, executable by the processor 1120 in the terminal 1100, for performing the above-described methods. For example, the non-transitory computer-readable storage medium may be a ROM, a RAM, a CD-ROM, a magnetic tape, a floppy disc, an optical data storage device or the like.

The non-transitory computer-readable storage medium has stored therein instructions that, when executed by a processor of the terminal 1100, cause the terminal 1100 to perform the above methods.

According to one aspect of the embodiments of this disclosure, an application calling management apparatus is provided. The apparatus may include: an acquiring module configured to acquire a background calling message sent by a first application, the background calling message requesting at least one target application to be called; a first determining module configured to determine a calling rule corresponding to a current calling according to the background calling message; a second determining module configured to, if a first calling rule matching the calling rule corresponding to the current calling exists in a terminal-disallowing-calling list, determine from the at least one target application at least one application disallowed to be called according to the first calling rule, wherein the terminal-disallowing-calling list comprises at least one calling rule for controlling disallowance of calling, and the at least one application disallowed to be called is all or some of the at least one target application; and a disallowing module configured to disallow starting in background the application disallowed to be called.

According to another aspect of the embodiments of this disclosure, an application calling management apparatus is provided. The apparatus may include: a determining module configured to receive a background calling message sent by a first application and determine at least one target application corresponding to the background calling message; an acquiring module configured to acquire a pre-stored terminal-disallowing-calling list corresponding to the first application, the terminal-disallowing-calling list recording at least one application; and a starting module configured to start in background an application among the at least one target application which is not included in the terminal-disallowing-calling list, and to disallow starting in background an application among the at least one target application which is included in the terminal-disallowing-calling list.

According to an additional aspect of the embodiments of this disclosure, an application calling management apparatus is provided. The apparatus may include: a processor; and a memory configured to store instructions executable by the processor. The processor is configured to: receive a background calling message sent by a first application and determine at least one target application corresponding to the background calling message; acquire a pre-stored terminal-disallowing-calling list corresponding to the first application, the terminal-disallowing-calling list recording at least one application; and start in background an application among the at least one target application which is not included in the terminal-disallowing-calling list, and disallow starting in background an application among the at least one target application which is included in the terminal-disallowing-calling list.

The technical solutions according to the embodiments of the disclosure have the following beneficial effects. A calling rule corresponding to a current calling is determined according to the background calling message; if a first calling rule matching the calling rule corresponding to the current calling exists in a terminal-disallowing-calling list, at least one application disallowed to be called is determined from the at least one target application according to the first calling rule; and it is disallowed to start in background the application disallowed to be called. In this way, when the first application calls and starts other applications in background, the system program can disallow starting some application(s) in background based on the terminal-disallowing-calling list. Thus, the power consumption of the terminal can be reduced.

It should be understood that “a plurality of/multiple” mentioned in this disclosure refers to two or more. The expression “and/or” represents three cases. For example, “A and/or B” may represent cases where only A exists, both A and B exist and only B exists. The symbol “/” represents “or”.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. The specification and examples are intended to be exemplary only, with a true scope and spirit of the disclosure being indicated by the following claims.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. An application calling management method, comprising:
acquiring a background calling message sent by a first application, the background calling message requesting at least one target application to be called;
determining a calling rule corresponding to a current calling, according to the background calling message;
if a first calling rule matching the calling rule corresponding to the current calling exists in a terminal-disallowing-calling list, determining from the at least one target application at least one application disallowed to be called according to the first calling rule, wherein the terminal-disallowing-calling list comprises at least one calling rule for controlling disallowance of calling, and the at least one application disallowed to be called is at least some of the at least one target application; and
disallowing starting in background the application disallowed to be called.

2. The method according to claim 1, further comprising:
if a second calling rule matching the calling rule corresponding to the current calling exists in a terminal-allowing-calling list, determining from the at least one target application at least one application allowed to be called according to the second calling rule, wherein the terminal-allowing-calling list comprises at least one calling rule for controlling allowance of calling, and the at least one application allowed to be called is at least some of the at least one target application; and
starting in background the application allowed to be called.

3. The method according to claim 2, further comprising:
if the at least one target application comprises an application undetermined as to whether to be called in addition to the application disallowed to be called and the application allowed to be called, displaying an inquiry message for inquiring a user whether the application undetermined as to whether to be called is allowed to be called;
after acquiring a disallowing instruction for the inquiry message, disallowing starting in background the application undetermined as to whether to be called;
after acquiring an allowing instruction for the inquiry message, starting in background the application undetermined as to whether to be called.

4. The method according to any of claim 1, wherein the calling rule comprises at least one of: a caller, a callee, a called operation, a called class name and a calling type.

5. The method according to claim 4, wherein:
the calling rule corresponding to the current calling comprises the caller for the current calling, and
determining the calling rule corresponding to the current calling according to the background calling message comprises determining the first application which sends the background calling message as the caller for the current calling.

6. The method according to claim 4, wherein:
the calling rule corresponding to the current calling comprises the callee for the current calling, and
determining the calling rule corresponding to the current calling according to the background calling message comprises:
acquiring an application identification carried by the background calling message, and determining a target application indicated by the application identification as the callee for the current calling, or
acquiring target operation information carried by the background calling message, and determining among locally installed applications the target application, which supports an operation corresponding to the target operation information, as the callee for the current calling.

7. The method according to claim 4, wherein:
the calling rule corresponding to the current calling comprises the called operation for the current calling, and
determining the calling rule corresponding to the current calling according to the background calling message comprises: acquiring target operation information carried by the background calling message, and determining an operation corresponding to the target operation information as the called operation for the current calling.

8. The method according to claim 4, wherein:
the calling rule corresponding to the current calling comprises the called class name for the current calling, and
determining the calling rule corresponding to the current calling according to the background calling message comprises: acquiring a target class name carried by the background calling message, and determining the target class name as the called class name for the current calling.

9. The method according to claim 4, wherein:
the calling rule corresponding to the current calling comprises the calling type for the current calling, and
determining the calling rule corresponding to the current calling according to the background calling message comprises: determining a target calling type adopted by the first application for sending the background calling message as the calling type for the current calling.

10. The method according to claim 2, further comprising:
sending a list acquiring request to a server, wherein the list acquiring request comprises identifications of locally installed applications, and the server is configured to acquire calling rules related to the locally installed applications from a general calling disallowance list to obtain the terminal-disallowing-calling list, and to acquire calling rules related to the locally installed applications from a general calling allowance list to obtain the terminal-allowing-calling list; and
receiving the terminal-disallowing-calling list and the terminal-allowing-calling list sent by the server.

11. The method according to claim 2, further comprising at least one of:
displaying at least one calling disallowance rule related to the first application; when acquiring a calling authorization instruction corresponding to a target calling disallowance rule, deleting the target calling disallowance rule from the terminal-disallowing-calling list, and adding the target calling disallowance rule into the terminal-allowing-calling list as a calling allowance rule; and
displaying at least one calling allowance rule related to the first application; when acquiring a calling prohibition instruction corresponding to a target calling allowance rule, deleting the target calling allowance rule from the terminal-allowing-calling list, and adding the target calling allowance rule into the terminal-disallowing-calling list as a calling disallowance rule.

12. An application calling management apparatus, comprising:
a processor; and
a memory configured to store instructions executable by the processor,
wherein the processor is configured to:
acquire a background calling message sent by a first application, the background calling message requesting at least one target application to be called;
determine a calling rule corresponding to a current calling according to the background calling message;
if a first calling rule matching the calling rule corresponding to the current calling exists in a terminal-disallowing-calling list, determine from the at least one target application at least one application disallowed to be called according to the first calling rule, wherein the terminal-disallowing-calling list comprises at least one calling rule for controlling disallowance of calling, and the at least one application disallowed to be called is at least some of the at least one target application; and
disallow starting in background the application disallowed to be called.

13. The application calling management apparatus of claim 12, wherein the processor is further configured to:
if a second calling rule matching the calling rule corresponding to the current calling exists in a terminal-allowing-calling list, determine from the at least one target application at least one application allowed to be called according to the second calling rule, wherein the terminal-allowing-calling list comprises at least one calling rule for controlling allowance of calling, and the at least one application allowed to be called is at least some of the at least one target application; and
start in background the application allowed to be called.

14. The application calling management apparatus of claim 13, wherein the processor is further configured to:
if the at least one target application comprises an application undetermined as to whether to be called in addition to the application disallowed to be called and the application allowed to be called, display an inquiry message for inquiring a user whether the application undetermined as to whether to be called is allowed to be called;
after acquiring a disallowing instruction for the inquiry message, disallow starting in background the application undetermined as to whether to be called;
after acquiring an allowing instruction for the inquiry message, start in background the application undetermined as to whether to be called.

15. The application calling management apparatus of claim 12, wherein the calling rule comprises at least one of: a caller, a callee, a called operation, a called class name and a calling type.

16. The application calling management apparatus of claim 15, wherein:
the calling rule corresponding to the current calling comprises the caller for the current calling, and
the processor to determine the calling rule corresponding to the current calling according to the background calling message is further configured to determine the first application which sends the background calling message as the caller for the current calling.

17. The application calling management apparatus of claim 15, wherein:
the calling rule corresponding to the current calling comprises the callee for the current calling, and
the processor to determine the calling rule corresponding to the current calling according to the background calling message is further configured to:
acquire an application identification carried by the background calling message, and determine a target application indicated by the application identification as the callee for the current calling, or
acquire target operation information carried by the background calling message, and determine among locally installed applications the target application, which supports an operation corresponding to the target operation information, as the callee for the current calling.

18. The application calling management apparatus of claim 15, wherein:
the calling rule corresponding to the current calling comprises the called operation for the current calling, and
the processor to determine the calling rule corresponding to the current calling according to the background calling message is further configured to: acquire target operation information carried by the background calling message, and determine an operation corresponding to the target operation information as the called operation for the current calling.

19. The application calling management apparatus of claim 15, wherein:
the calling rule corresponding to the current calling comprises the called class name for the current calling, and
the processor to determine the calling rule corresponding to the current calling according to the background calling message is further configured to: acquire a target class name carried by the background calling message, and determine the target class name as the called class name for the current calling.

20. An application calling management method, comprising:
receiving a background calling message sent by a first application and determining at least one target application corresponding to the background calling message;
acquiring a pre-stored terminal-disallowing-calling list corresponding to the first application, the terminal-disallowing-calling list recording at least one application; and
starting in background an application among the at least one target application which is not included in the terminal-disallowing-calling list, and disallowing starting in background an application among the at least one target application which is included in the terminal-disallowing-calling list.
